(19) United States
(12) Patent Application Publication
(10) Pub. No.: US 2012/0288370 A1
(43) Pub. Date: Nov. 15, 2012

(54) FASTENING AN AXIAL BEARING DISK IN A MAGNETICALLY-MOUNTED TURBOMACHINE BY MEANS OF A SHRINK DISK CONNECTION

(76) Inventor: Helmut Kühn, Mengelsdorf (DE)

(21) Appl. No.: 13/466,420

(22) Filed: May 8, 2012

(30) Foreign Application Priority Data
May 10, 2011 (DE) 102011075583.7

(51) Int. Cl. F01D 25/00; B23P 17/00; F01D 1/02

(52) U.S. Cl. 415/229; 29/888

(57) ABSTRACT

A turbomachine includes a housing and a shaft mounted rotatably relative to the housing about a rotary axis, an element with a through opening through which the shaft protrudes, a first ring element and a second ring element. The first ring element is arranged with its inner surface on the shaft and the element is fixed by the first ring element at a predetermined position on the shaft. The second ring element is arranged with its inner surface lying on the outer surface of the first ring element, which outer surface tapers conically from a first axial end to a second axially opposite axial end. The inner surface of the second ring element tapers conically in a complementary way to the outer surface of the first ring element. An axial movement of the second ring element relative to the first ring element compresses the first ring element against the shaft.

### CROSS REFERENCE TO RELATED APPLICATIONS

This application claims priority of German Patent Office application No. 102011075583.7 DE filed May 10, 2011. All of the applications are incorporated by reference herein in their entirety.

### FIELD OF INVENTION

The present invention relates to a turbomachine and a method for establishing a compression connection between a first ring element and a shaft of a turbomachine.

### BACKGROUND OF INVENTION

In turbomachines, such as for example, a turbocompressor or a turbine, rotor blades are arranged on a rotatable shaft around which a flow medium flows. The shaft of a turbomachine is mounted rotatably with axial and radial bearings in a bearing housing of the turbomachine.

In conventional bearings, friction bearings, for example, are used to mount the shaft in the bearing housing. Also used are magnetic bearings which enable frictionless rotatable mounting of the shaft. Here, magnetic forces are used to mount the shaft rotatably in a predetermined axial and/or radial position. Magnetic bearings can be embodied as passive magnetic bearings. In the case of passive magnetic bearings, diamagnetic materials are used, for example. In the case of active magnetic bearings, the bearing force is established by adjustable electromagnets. The electromagnets can be controlled in order to establish a desired magnetic force to hold the shaft in a predetermined radial and/or axial position.

In the case of active magnetic bearings, the shaft comprises an axial bearing disk held rotatably in a predetermined position between two stator elements, which are fastened to the bearing housing. The axial bearing disk is usually formed integrally during the production of the shaft. For example, the axial bearing disk is turned by means of turning or milling from the basic body of the shaft.

Alternatively, it is also possible to shrink the axial bearing disk directly onto the shaft. Shrink fitting uses the principle of thermal expansion of the two elements, the shaft and the axial bearing disk. When the axial bearing disk is mounted, it is, for example, heated and pushed onto the shaft in heated condition. When the axial bearing disk has cooled, it contracts so that an interference fit of the axial bearing disk on the shaft is established.

The stator elements of an active magnetic bearing comprise coils to generate the electromagnetic forces. In order to minimize the interference on the electromagnetic flow, if possible, the stator elements should not have any axial part surfaces. The stator elements then each form an enclosed stator ring. When the shaft is mounted, the axial bearing disk is disposed between two stator rings of this kind.

If, for example, due to a defect, one of the stator rings has to be removed, it is mandatorily necessary to pull the axial bearing disk off the shaft in order to reach and replace the defective stator ring. If the axial bearing disk is formed in one piece with the shaft, the entire shaft has to be removed. If the axial bearing disk is shrunk onto the shaft, it can be sufficient to remove the axial bearing disk, wherein the loosening of the interference fit of the shrunk-on axial bearing disk is very laborious.

### SUMMARY OF INVENTION

It is an object of the present invention to provide a simple and detachable fastening means for an element rotatably fastened to a shaft for a turbomachine.

The object is achieved by a turbomachine and a method for establishing a compression connection between a first ring element and a shaft of a turbomachine according to the independent claims.

A first aspect of the present invention describes a turbomachine. The turbomachine comprises a housing and a shaft mounted rotatably about a rotary axis relative to the housing, wherein a radial direction extends perpendicular to the rotary axis. The turbomachine also comprises an element with a through opening, wherein the shaft protrudes through the opening and the element is arranged at a predetermined position on the shaft. The turbomachine also comprises a first ring element and a second ring element. The first ring element is embodied with a first inner surface in the radial direction and a first outer surface in the radial direction. The second ring element is embodied with a second inner surface in the radial direction. The first ring element is arranged with the first inner surface lying (directly or indirectly) on the shaft and the element is fixed by means of the first ring element at the predetermined position on the shaft. The second ring element is arranged with the second inner surface lying on the first outer surface of the first ring element. The first outer surface tapers conically from a first axial end of the first outer surface to a second axially opposite axial end of the first outer surface and the second inner surface tapers conically in a complementary way to the first outer surface so that, by means of an axial displacement of the second ring element relative to the first ring element, the first ring element is exposed to a radial tension force and hence a compression connection is established between the first ring element and the shaft.

A further aspect of the present invention describes a method for establishing a compression connection between a first ring element and a shaft of a turbomachine. The shaft is mounted relative to the housing rotatably about a rotary axis, wherein a radial direction extends perpendicular to the rotary axis. The shaft passes through a through opening of an element. The element is arranged at a predetermined position on the shaft. The first ring element is arranged with a first inner surface of the first ring element on the shaft (indirectly or directly), wherein the first ring element fixes the element by means of the first ring element at the predetermined position on the shaft. A second inner surface in the radial direction of a second ring element lies on a first outer surface in the radial direction of the first ring element. The first outer surface tapers conically from a first axial end of the first outer surface to a second axially opposite end and the second inner surface tapers conically in a complementary way to the first outer surface. The second ring element is displaced counter to the first direction relative to the first element. The displacement of the second ring element relative to the first ring element causes the first ring element to be exposed to a radial tension force thus establishing a compression connection between the first ring element and the shaft.

For the purposes of the present application a “turbomachine” means a fluid energy machine with which the energy transmission between fluid and machine takes place with a flow obeying the laws of fluid dynamics. The energy transmission takes place on rotating rotor blades arranged non-rotatably on the rotatable shaft. If the turbomachine is a compressor, the rotatable shaft is driven and the rotor blades compress the fluid the fluid flowing past the rotor blades. If the turbomachine is a turbine, a high-energy fluid flows against the rotor blades and drives them and hence the rotatable shaft. A turbomachine can, for example, be a turbocompressor, a gas turbine, a steam turbine, a jet engine or another type of turbine or a compressor with an axial or radial design.

The shaft of the turbomachine is mounted rotatably with respect to the housing, in particular a bearing housing, of the turbomachine. The shaft of the turbomachine comprises the rotary axis. A direction parallel to the rotary axis is defined as the axial direction of the shaft. A direction extending through the center point of the shaft and which is oriented perpendicular to the rotary axis is referred to as the radial direction of the shaft and the turbomachine.

For the purposes of this application, the word “element” should be understood as meaning components that can be fastened non-rotatably to the shaft of the turbomachine. The element can, for example, be a rotor blade, a rotor blade support, a bearing ring or a bearing disk. The element comprises the through opening through which the shaft can be pushed until the element reaches its predetermined position on the shaft in the axial direction.

The first ring element is for example a tension ring or a clamping ring. The exertion of a radial tension force causes the internal diameter of the first ring element to be reduced so that the compression connection between the ring element and the shaft can be established. To reduce its internal diameter, the ring element, embodied as a clamping ring, can comprise a gap in the circumferential direction and hence have an open ring-shaped profile shape with two free ends along the circumferential direction. The first ring element can also be an enclosed ring, wherein the first ring element can be embodied as deformable, for example elastically deformable, in order to reduce its diameter on the exertion of the radial tension force.

The internal diameter of the second ring element is embodied such that the second ring element can be pushed over the first ring element and can be fastened lying on the outer surface of the first ring element.

The first outer surface of the first ring element tapers conically between the first end and the axially opposite end. Here, a surface contour is described along a first direction extending parallel to the rotary axis, said surface contour extending along the first direction not parallel to the rotary axis. At the first axial end of the first ring element, the first outer surface comprises, for example, a first distance to the rotary axis. At the second end of the first ring element lying opposite to the first axial end, the first outer surface comprises, for example, a second distance to the rotary axis. If the first outer surface tapers conically along the first direction, the first distance of the first outer surface to the rotary axis is larger than the second distance. In other words, the first ring element has a wedge-shaped profile. Expressed another way, a line extending in the axial direction along the first outer surface has an angle larger than 0° and smaller than 90° to the rotary axis.

The conically tapering inner surface of the second ring element is described corresponding to the first outer surface. The second inner surface of the second ring element tapers conically in a complementary way to the first outer surface. In other words, a line extending along the second inner surface from an axial end to an opposite axial end of the second ring element has the same angle to the rotary axis as the line extending on the first outer surface from an axial first end of the first ring element along the first direction to the opposite second end of the first ring element.

The first ring element and the second ring element form a shrink disk connection. If the second outer ring element is pushed onto the first internal ring element counter to the first direction, the first ring element and the second ring element brace each other due to their contact surfaces tapering conically toward each other in a complementary way (first outer surface and second internal surface). The second ring element can generally be pushed along an axial direction onto the first ring element. The application of an axial tension force causes a radial tension force to be established via the conically tapering contact surfaces of the first ring element and of the second ring element. This radial tension force causes a reduction in the internal diameter of the first ring element. This establishes the compression connection between the first ring element and the shaft.

To loosen the compression connection, the axial tension force is reduced and the second ring element is separated from the first ring element. Due to the fact that the contact surfaces of the first ring element and the second ring element are embodied conically in a complementary way, it is easy to loosen the first ring element and the second ring element. The compression connection formed by means of the first ring element and the second ring element can be established repeatedly.

The element can, for example, lie on an axial end of the first ring element and hence be fixed so that, when the compression connection is established between the first ring element and the shaft, axial displacement of the element over the first ring element is prevented. The element can also be arranged with a fastening area between the first inner surface and a shaft surface of the shaft so that, when the compression connection is established, the fastening area between the first ring element and the shaft is clamped. Hence, a fixing of the element on the shaft is also achieved.

With the above-described shrink disk connection, the element is fixed detachably in a simple way on the rotatable shaft of the turbomachine. Due to the ease of loosening of the shrink disk connection due to the reduction or cancellation of the axial tension force and the removal of the second ring element from the first ring element, the element can be quickly removed from the shaft so that components of the turbomachine which can only be accessed with difficulty because they are covered by the element, are accessible. Complicated dismantling of the entire shaft is not necessary. In addition, the components covered by the element do not have to be embodied in several parts in order, for example, to be detachable even without dismantling the element.

In particular, according to a further exemplary embodiment, the element is a bearing disk. The bearing disk can, for example, be mounted between two ball bearings, which are fastened to a housing of the turbomachine. The bearing disk enables, for example, an axial and a radial mounting of the shaft.

According to a further exemplary embodiment, the turbomachine comprises a magnetic bearing. In particular, here, the turbomachine comprises a first stator ring to generate an electromagnetic bearing force. The first stator ring comprises a first opening, which is larger than the shaft so that the shaft is arranged in a contactless manner with respect to the first stator ring. The first stator ring is arranged in such a way that that the electromagnetic bearing force enables a constant axial distance or a constant radial distance to the bearing disk to be maintained. The stator ring is, for example, fastened to the housing of the turbomachine. The electromagnetic bearing force of the stator ring keeps a predetermined distance between the stator ring and the bearing disk constant, wherein the bearing disk is nevertheless rotatable with the shaft relative to the first stator ring.

According to a further exemplary embodiment, the turbomachine comprises a second stator ring to generate a further electromagnetic bearing force. The second stator ring comprises a second opening, which is larger than the shaft so that the shaft is arranged contactlessly with respect to the second stator ring. The second stator ring is arranged in such a way that that the bearing disk lies between the first stator ring and the second stator ring and that a further constant axial distance or a further constant radial distance between the second stator ring and the bearing disk can be maintained by means of the further electromagnetic bearing force.

The first stator ring and the second stator ring each comprise coils arranged in the circumferential direction of the shaft. Hence, the first stator ring and/or the second stator ring can generate a constant electromagnetic force over the entire circumference around the shaft and hence keep a radial or axial distance between the respective stator ring and the bearing disk constant. This facilitates contactless mounting of the bearing disk and hence of the shaft.

Since the stator ring, which is arranged axially within the turbomachine, is often locked in the axial direction by the bearing disk, when conventional methods are used to fasten the bearing disk on the shaft, this locked stator ring can only be dismantled with difficulty. It is often necessary to dismantle the entire shaft or embody the stator ring in two parts, i.e. with a division. However, a division of the stator rings of this kind interferes with the electromagnetic field so that the electromagnetic bearing force is disrupted. The present simpler fixing of the element or the bearing disk by means of the shrink disk connection, formed by the first and second ring element, enables the first and second ring element to be loosened in a simpler way and hence also the bearing disk to be simply removed so that the locked stator ring is accessible.

According to a further exemplary embodiment, the first ring element lies with the first inner surface on a surface of the shaft (directly). Hence, the compression connection is formed exclusively between the first ring element and the shaft. Hence, no press force is exerted on the actual element. If the element lies on the first ring element, the above described exemplary embodiment prevents the element slipping in the axial direction and hence implements the fixing of the element on the shaft.

According to a further exemplary embodiment, the element comprises a fastening section. The fastening section is arranged between the first inner surface of the first ring element and the shaft so that, by means of the displacement of the second ring element relative to the first ring element, the first ring element is exposed to a radial tension force and hence a compression connection is established between the first ring element, the fastening section and the shaft.

The fastening section forms, for example, a flange-shaped extension in the axial direction of the element. The fastening section can hence, for example, be embodied in a tubular shape, wherein the inner diameter of the fastening section can correspond to the outer diameter of the shaft at the predetermined position. The fastening section further comprises a radial outer surface on which the first inner surface of the first ring element lies. When the second ring element is exposed to the radial tension force, the diameter of said ring element is reduced so that the radial tension force is also transferred to the fastening section. The fastening section is set up in such a way that that, on exposure to the radial tension force, its inner diameter is also reduced enabling the compression connection with the shaft to be established. The fastening section is embodied in such a way that that, on exposure to the radial tension force, said fastening section is deformable (in particular elastically deformable) so that the compression connection can be established. The fastening section can also have a gap in the circumferential direction in order to establish better deformability of the fastening section.

According to a further exemplary embodiment, the turbomachine further comprises a (detachable) tensioning element for the axial displacement of the second ring element relative to the first ring element. The tensioning element can be arranged in such a way that an axial tension force can be established against the first direction to tension the second ring element on the first ring element in order to establish a detachable compression connection between the first ring element and the shaft.

The tensioning element can comprise, for example, a detachable clamping jaw or a detachable screw. For example, a screw connection can be provided between the second ring element and the element. If the screw is tightened, the second ring element is pushed in the direction of the element, in particular against the first direction, so that the second element is tensioned on the first ring element and in this way the radial tension force is established. The screw can be used to set the size of the radial tension force via the torque of the screw. A screw connection also facilitates a simple release of the compression connection.

According to a further exemplary embodiment, the turbomachine further comprises a further first ring element and a further second ring element. The further first ring element is embodied with a further first inner surface in the radial direction and a further first outer surface in the radial direction. The further second ring element is embodied with a further a second inner surface in the radial direction. The further first ring element is arranged with the further first inner surface on the shaft and the element is fixed by means of the further first ring element at a predetermined position on the shaft. The further second ring element is arranged with the second inner surface lying on the further first outer surface of the further first ring element.

The element is arranged between the first ring element and the second ring element, on the one hand, and the further first ring element and the second ring element, on the other hand, on the shaft.

The further first outer surface tapers conically from a first axial end of the further first outer surface to a second axially opposite axial end of the further first outer surface and the further second inner surface tapers conically in a complementary way to the further first outer surface so that, by means of the displacement of the further second ring element relative to the further first ring element, the further first ring element is exposed to a further radial tension force so that a compression connection can be established between the further first ring element and the shaft.

The further first ring element and the further second ring element can comprise the same features and have the same design as the first ring element and the second ring element. In particular, the conically tapering surfaces of the first and second ring elements are opposite to the conical tapering of the surfaces of the further first ring elements and further second ring elements. The first ring element lies on a first axial end of the element and the further first ring element lies on an opposite end of the element so that an axial displacement of the element is prevented due to the first two ring elements.

The present invention in particular provides a turbomachine with which the (axial) bearing disk is fastened by magnetically mounted (for example turbomachine) shafts by means of the above-described shrink disk connection, comprising the first ring element and the second ring element, on the shaft in order to achieve simple means for mounting and dismantling the bearing disk.

Reference is made to the fact that the embodiments described here only represent a restricted selection of possible variants of the invention. For example, it is possible to combine the features of individual embodiments with each other in a suitable way so that the person skilled in the art will consider that the explicit variants described here obviously disclose a plurality of different embodiments.

### BRIEF DESCRIPTION OF THE DRAWINGS

For further explanation and better understanding of the present invention, the following is a description of exemplary embodiments with reference to the attached FIGURE.

The FIGURE is a schematic drawing of a part of a turbomachine in which an element is fixed on the shaft by means of a shrink disk connection, according to an exemplary embodiment of the present invention.

### DETAILED DESCRIPTION OF INVENTION

In the FIGURE, identical or similar components are given the same reference numbers. The depiction in the FIGURE is schematic and not to scale.

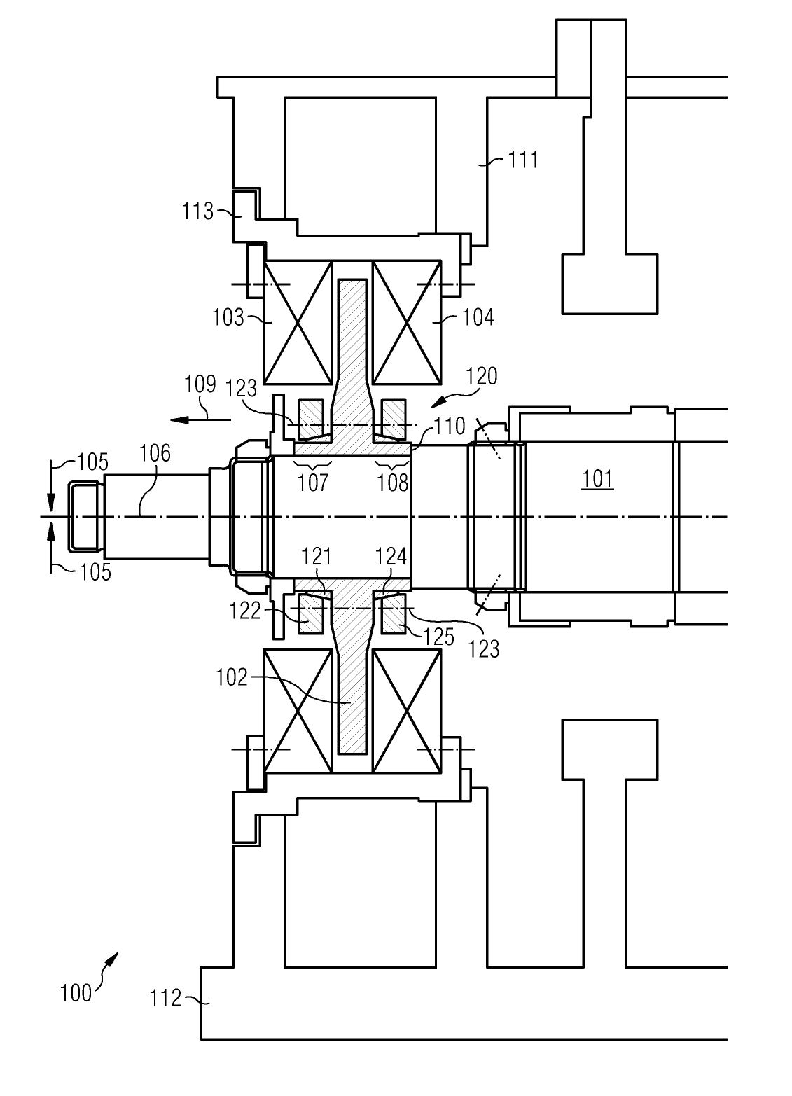

The FIGURE shows a turbomachine 100 comprising a housing or a bearing housing 113, in particular an axial bearing housing, and a shaft 101 mounted rotatably therein about a rotary axis 106. The turbomachine 100 also comprises an element 102 with a through opening, wherein the shaft 101 protrudes through the opening and the element 102 is arranged at a predetermined position on the shaft 101. In FIG. 1, the element 102 is, for example, a bearing disk.

The turbomachine 100 also comprises a first ring element 121 and a second ring element 122. The first ring element 121 is embodied with a first inner surface in the radial direction 105 and a first outer surface in the radial direction 105. The second ring element 122 is embodied with a second inner surface in the radial direction 105. The first ring element 121 is fastened with the first inner surface on the shaft 101. The first ring element 121 is embodied in such a way that the element 102 can be fixed in a predetermined position on the shaft 101 by means of the first ring element 121. In FIG. 1, the first ring element 121 is embodied in such a way that the element 102 is, for example, unable to perform an axial and radial movement relative to the first ring element 121.

The second ring element 122 is arranged with the second inner surface lying on the first outer surface of the first ring element 121. The first outer surface runs along a first direction 109 tapering conically parallel to the rotary axis 106 and the second inner surface tapers conically along the first direction 109 and in a complementary way to the first outer surface in such a way that that, by means of the displacement or tensioning of the second ring element 122 against the first direction 109 onto the ring element 121, the first ring element 121 is exposed to a radial tension force.

The radial tension force causes the internal diameter of the first ring element 121 to be reduced so that a compression connection can be established between the first ring element 121 and the shaft 101.

The FIGURE shows the element 102, the first ring element 121, the second ring element 122 and the element 102 in a cutting plane (see hatched regions). The conical shapes of the first outer surface and the second inner surface are shown in the cutting plane. As the FIGURE shows, due to their complementary conically tapering embodiment, the first outer surface and the second inner surface have a wedge shape in the cross-sectional plane. Here, the second inner surface tapers conically in a complementary way to the first outer surface so that there is a contact surface between the second inner surface and the first outer surface.

A line, which extends within the cross-sectional plane and extends on the first outer surface and on the second inner surface, comprises an angle to the rotary axis and is therefore not parallel to the rotary axis.

If the second ring element 122 is now pushed against the first direction 109 in the axial direction, due to the conical contact surfaces of the first and of the second ring element 121, 122, this pushing creates a radial tension force with at least one component in the radial direction 105. This establishes the compression connection between the first ring element 121 and the shaft 101.

Displacement of the element 102 over the first ring element 121 is prevented since the first ring element 121 (with its outer diameter) is embodied larger than an inner diameter of the element 102. At the opposite axial end of the element 102 in the axial direction and counter to the first direction 109, the element can be in contact with a shaft shoulder 110. This prevents further displacement of the element 102 against the first direction 109.

Additionally or alternatively to the shaft shoulder 110, a further first ring element 124 and a further second ring element 125 can be provided in order to prevent displacement of the element 102 against the first direction 109. The further first ring element 124 and the further second ring element 125 can correspondingly comprise the features and the embodiments of the first ring element 121 and the second ring element 122. To improve ease of assembly, here the further first outer surface of the further first ring element 124 and the further second inner surface of the further second ring element 125 can taper conically opposite to the first ring element 122 and the second ring element 122. Hence, to tension the further second ring element 125, this has to be pushed along the first direction 109 onto the further first ring element 124 so that the further first ring element 124 is exposed to a further radial tension force.

As shown in the FIGURE, the element 102 can comprise a fastening section 107 and a further fastening section 108. The fastening sections 107, 108 are each arranged between the shaft 101 and the respective first ring element 121, 124. The fastening sections 107, 108 comprise a tubular extension of the element 102 in the axial direction. The exertion of the respective radial tension force on the respective first ring element 121, 124 establishes a compression connection between the respective first ring element 121, the respective fastening sections 107, 108 and the shaft 101.

The turbomachine 100 also comprises one or more detachable tensioning elements 123. The detachable tensioning element 123 can, for example, be a screw. The second ring element 122 and the element 101 each comprise a hole in the axial direction. As a detachable tensioning element 123, the screw can be screwed between the second ring element 122 and the element 102 in such a way that the screwing-in of the screw exerts an axial tension force so that the second ring element 122 is pushed against the first direction 109 onto the first ring element 121 so that the radial tension force is created.

In addition, in a further exemplary embodiment, the further second ring element 125 can comprise a hole (in particular a threaded hole), wherein the holes in the second ring element 122, the element 102 and the further second ring element 125 are embodied as coaxial. Hence, as a tensioning element 123, a screw can connect the second ring element 122, the element 101 and the further second ring element 125 and exert an axial tension force on the second ring element 122 and the further second ring element 125 by means of screwing. The screw draws the second ring element 122 and the further second ring element 125 axially together so that this simultaneously creates the radial tension force of the first ring element 121 and the further radial tension force of the further first ring element 124. Hence, the compression connection can be established quickly in a simple way. Loosening the screw enables the established compression connection to be undone so that the element 102 can be dismantled quickly.

The FIGURE also shows a first stator ring 103 and a second stator ring 104. The element 102, which is embodied in FIG. 1 as a bearing disk, is arranged rotatably between the two stator rings 103, 104, and at a distance from the respective stator rings 103, 104. The stator rings 103, 104 generate an electromagnetic field, which keeps the axial distance of the element 102 to the respective stator ring 103, 104 constant so that contactless mounting is facilitated.

The stator rings 103, 104 can be fastened to the bearing housing 113, which is embodied with a bearing housing upper part 111 and a bearing housing lower part 112 on the turbine.

In addition, it should be noted that the word “comprising” does not exclude other elements or steps and the indefinite article “a” or “an” does not exclude a plurality. It is also noted that features or steps described with reference to one of the above exemplary embodiments can also be used in combination with other features or steps of the above-described exemplary embodiments. Reference numbers in the claims should not be considered to be restrictions.

1. A turbomachine, comprising:
a housing,
a shaft mounted rotatably relative to the housing about a rotary axis, wherein a radial direction extends perpendicular to the rotary axis,
an element with a through opening, wherein the shaft protrudes through the opening and the element is arranged at a predetermined position on the shaft,
a first ring element, and
a second ring element,
wherein the first ring element is embodied with a first inner surface in the radial direction and a first outer surface in the radial direction,
wherein the second ring element is embodied with a second inner surface in the radial direction,
wherein the first ring element is arranged with the first inner surface on the shaft and the element is fixed via the first ring element at the predetermined position on the shaft,
wherein the second ring element is arranged with the second inner surface lying on the first outer surface of the first ring element, and
wherein the first outer surface run conically from a first axial end of the first outer surface to a second axially opposite axial end of the first outer surface and the second inner surface tapers conically in a complementary way to the first outer surface so that, by an axial displacement of the second ring element relative to the first ring element, the first ring element is exposed to a radial tension force and a compression connection is established between the first ring element and the shaft.

2. The turbomachine as claimed in claim 1, wherein the element is a bearing disk.

3. The turbomachine as claimed in claim 2, further comprising:
a first stator ring to generate an electromagnetic bearing force,
wherein the first stator ring comprises a first opening, which is larger than the shaft so that the shaft is arranged contactlessly with respect to the first stator ring, and
wherein the first stator ring is arranged in such a way that the electromagnetic bearing force enables a constant axial distance or a constant radial distance to the bearing disk to be maintained.

4. The turbomachine as claimed in claim 3, further comprising:
a second stator ring, to generate a further electromagnetic bearing force,
wherein the second stator ring has a second opening, which is larger than the shaft so that the shaft is arranged contactlessly with respect to the second stator ring, and
wherein the second stator ring is arranged in such a way that the bearing disk is disposed between the first stator ring and the second stator ring and a further constant axial distance or a further constant radial distance can be maintained between the second stator ring and the bearing disk via the further electromagnetic bearing force.

5. The turbomachine as claimed in claim 1, wherein the first ring element is arranged with the first inner surface lying on a surface of the shaft.

6. The turbomachine as claimed in claim 1,
wherein the element comprising a fastening section, and
wherein the fastening section is arranged between the first inner surface of the first ring element and the shaft so that, by the displacement of the second ring element relative to the first ring element, the first ring element is exposed to the radial tension force and hence the compression connection between the first ring element, the fastening section and the shaft is established.

7. The turbomachine as claimed in claim 1, further comprising a tensioning element for the axial displacement of the second ring element relative to the first ring element.

8. The turbomachine as claimed in claim 1, further comprising:
a further first ring element, and
a further second ring element,
wherein the further first ring element is embodied with a further first inner surface in the radial direction and a further first outer surface in the radial direction,
wherein the further second ring element is embodied with a further second inner surface in the radial direction,
wherein the further first ring element is arranged with the further first inner surface on the shaft and the element is fixed via the further first ring element at the predetermined position on the shaft,
wherein the further second ring element is arranged with the further second inner surface lying on the further first outer surface of the further first ring element,
wherein the element between
a) the first ring element and the second ring element on the one hand and
b) the further first ring element and the second ring element on the other hand on the shaft, and
wherein the further first outer surface tapers conically from a further first axial end of the first outer surface to a further second axially opposite axial end of the first outer surface and the further second inner surface tapers conically in a complementary way to the further first outer surface in such a way that that, by the displacement of the further second ring element relative to the further first ring element, the further first ring element is exposed to a further radial tension force and hence a further compression connection is established between the further first ring element and the shaft.

9. A method for establishing a compression connection between a first ring element and a shaft of a turbomachine, the method comprising:
rotatably mounting the shaft relative to the housing about a rotary axis, wherein a radial direction extends perpendicular to the rotary axis,
passing the shaft through a through opening of an element,
arranging the element at a predetermined position on the shaft,
arranging the first ring element with a first inner surface of the first ring element on the shaft, wherein the first ring element fixes the element via the first ring element at the predetermined position on the shaft,
arranging a second inner surface of a second ring element in the radial direction lying on a first outer surface of the first ring element in the radial direction, wherein the first outer surface tapers conically from a first axial end of the first outer surface to a second axially opposite axial end of the first outer surface and the second inner surface tapers conically in a complementary way to the first outer surface, and
displacing the second ring element relative to the first ring element, wherein, by the displacement of the second ring element relative to the first ring element, the first ring element is exposed to a radial tension force and a compression connection is established between the first ring element and the shaft.
